(19) United States
(12) Patent Application Publication
(10) Pub. No.: US 2006/0155397 A1
(43) Pub. Date: Jul. 13, 2006

(54) Method of operating a controller on a communication medium

(76) Inventors: Heinz Focke, Verden (DE); Doris Focke, Verden (DE); Jurgen Focke, Verden (DE); Hartmut Olbrich, Verden (DE); Christian Breitenstein, Bremen (DE); Thomas Tengen, Verden (DE)

Correspondence Address: LAURENCE P. COLTON, 1201 WEST PEACHTREE STREET, NW, 14TH FLOOR, ATLANTA, GA, 30309-3488, US

(21) Appl. No.: 10/797,225

(22) Filed: Mar. 10, 2004

(30) Foreign Application Priority Data
Mar. 21, 2003 (DE) 103 12 756.9

(51) Int. Cl. G05B 11/01; G05B 15/00; G05B 19/42

(52) U.S. Cl. 700/83; 700/19; 700/86; 700/20

(57) ABSTRACT

A method is specified of operating a device for controlling and/or monitoring a production and/or packaging installation on a bus (33), the controller (30) comprising an interface (34) to be connected to the bus (33), a main memory (36) for the storage of a control program (31) and also means for executing the control program (31). Configuration data (40) are stored in a removable memory module (39). When the controller (30) is restarted, the configuration data (40) are read out and, by using the configuration data (40), an access is made to a remote memory (32) which can be reached via the bus (33) and which comprises a transfer to the controller (30) of data stored in the remote memory (32).

### STATEMENT OF RELATED APPLICATIONS AND FOREIGN PRIORITY

The present application is based on and claims priority on German Patent Application No. 103 12 756.9 having a filing date of 21 Mar. 2003.

### BACKGROUND OF THE INVENTION

1. Technical Field

The present invention relates to a method of operating a device for controlling and/or monitoring a production and/or packaging installation, in particular an installation for the production and/or packaging of cigarettes, cigars and the like, on a communication medium, for example a bus. The aforementioned device will be referred to briefly below as a controller. The invention further relates to such a device, that is to say such a controller. The controller comprises an interface to be connected to the communication medium, a main memory for the storage of a control program, according to which the control and/or monitoring of the production and/or packaging installation is carried out, and also means for executing the control program.

2. Prior Art

Controllers of this type are generally known and in use in multifarious configurations in the automation of technical processes.

When such controllers are replaced, for example in the event of service, reconfiguration of the controller has hitherto disadvantageously been required.

### BRIEF SUMMARY OF THE INVENTION

The object of the invention is therefore to specify a method of operating a controller with which the replacement of controllers and the following restarting of the controller is made easier. A further object of the invention is to specify a controller with which the method can be carried out.

The object is achieved with a method of operating a device for controlling or monitoring a production and/or packaging installation for the production and/or packaging of cigarettes, cigars and the like—controller—on a communication medium, namely a bus, the controller comprising an interface to be connected to the communication medium, a main memory for the storage of a control program and also means for executing the control program, characterized in that configuration data are stored in a removeable memory module in that, when the controller is restarted, the configuration data are read out and in that, by using the configuration data, an access to a remote memory which can be reached via the communication medium is made, which comprises a transfer to the controller of data stored in the remote memory.

The object also is achieved with a device for controlling or monitoring a production and/or packaging installation for the production or packaging of cigarettes, cigars and the like—controller—comprising a main memory, in which a control program can be stored, a device for executing the control program and an interface for connection to a communication medium, in particular a bus, characterized in that configuration data, which can be read out and evaluated when the controller is restarted, are stored in a removeable memory module, the memory module being fixed at an installation location of the controller such that it can move.

According to these, in a method of operating a controller of the abovementioned type, provision is made for configuration data to be stored in a memory module which can be removed, in that, when the controller is restarted, the configuration data are read out and in that, by using the configuration data, an access to a remote memory which can be reached via the communication medium is made, which comprises a transfer to the controller of data stored in the remote memory.

A special feature of the method according to the invention is that the reading of the configuration data is triggered by an installation program stored in the main memory of the controller, and in that the installation program in the main memory of the controller is overwritten with the transfer of the data, specifically a copy of the control program stored in the remote memory.

A further special feature of the invention is that a multiplicity of copies of the control program is stored in the one or more remote memories and in that, when the controller is restarted, access is made to the last copy of the control program.

Finally, a special feature of the invention consists in the configuration data comprising machine data with regard to a machine for which the control program is provided, and in that, before or at the start of the control program, a comparison is made between the machine data and machine codes read in, and in that the control program is executed only in the case of machine codes matching the machine data.

### BRIEF DESCRIPTION OF THE DRAWINGS

Further special features of the invention will be explained in more detail below using the drawings, in which:

FIG. 1 shows a fabrication and packaging installation for cigarettes in schematic outline.

FIG. 2 shows a schematic representation of two communication participants, namely a controller and a remote memory, connected to a communication medium, a bus.

FIG. 3 shows a flow chart relating to individual method steps when starting or restarting the controller.

FIG. 4 shows a flow chart relating to individual method steps when executing a control program.

### DETAILED DESCRIPTION OF THE PREFERRED EMBODIMENTS

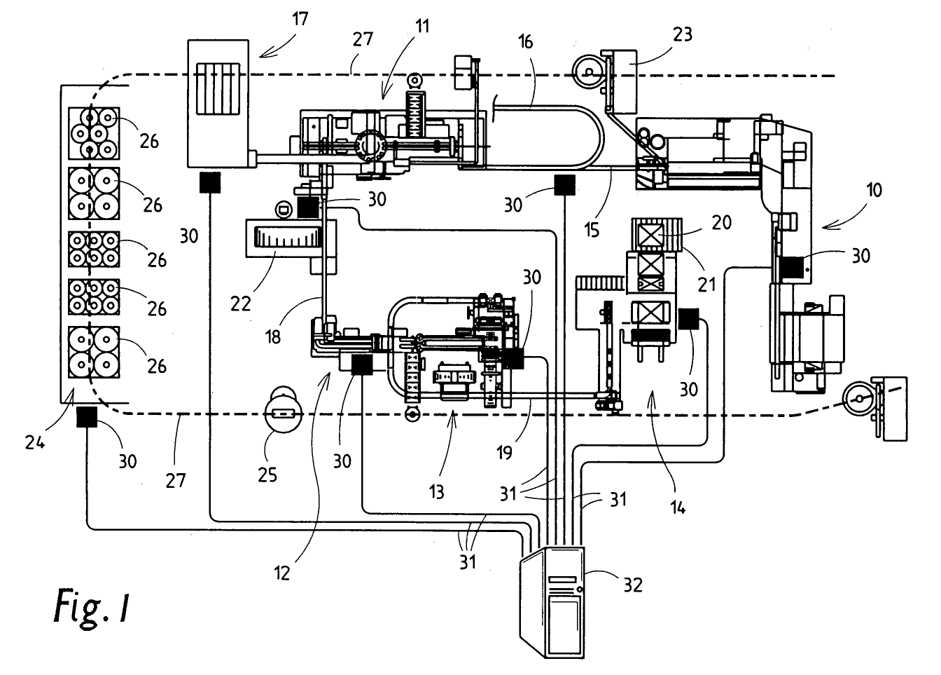

The exemplary embodiment illustrated in the drawings shown in FIGS. 1 through 4 relates to a fabrication and packaging installation for cigarettes, that is to say what is known as a line. This comprises fabrication units, for example a cigarette producing machine, specifically a maker 10, a packaging machine following the latter, a packer 11, a following film wrapping machine 12, a packaging machine for producing bundles from a plurality of cigarette packs, that is to say a carton packer 13, and a cartoner 14, which packs bundles of packs, that is to say cigarette cartons, into a dispatch carton. Cigarettes fabricated by the maker 10 are supplied by a cigarette conveyor 15 with an associated cigarette store 16 to the packer 11 for fabricating flip-top boxes. Associated with the packer 11 is a blank store 17, that is to say a device for accommodating a relatively large store of prefabricated blanks for the flip-top boxes. The cigarette packs fabricated by the packer 11 are supplied to the film wrapping machine 12 via a pack conveyor 18. This machine has the task of wrapping the cigarette packs in a film or plastic blank. From the finished cigarette packs, pack groups are formed which, in the region of the carton packer 13, are provided with a bundle wrapper and result in a cigarette carton normally comprising 10 cigarette packs. These cigarette cartons are fed to the cartoner 14 by a carton conveyor 19. The latter transfers finished dispatch cartons with a plurality of cigarette cartons to an output conveyor 21. In the region of the pack conveyor 18 between packer 11 and film wrapping machine 12 there is a pack store 22 to accommodate a relatively large number of cigarette packs. The maker 10 is assigned a filter-tipping machine 23. The fabrication units described must be supplied with material. For this purpose, a material store 24 is provided, from which, by means of a material conveyor 25, material can be removed, in particular in the form of wound webs, specifically bobbins 26, and fed to the individual fabrication units. For this purpose, the material conveyor 25 can move along a conveyor belt 27.

The individual fabrication unit, namely the maker 10, packer 11, film wrapping machine 12, carton packer 13, cartoner 14, cigarette conveyor 15 and cigarette store 16 and also the blank store 17, are assigned controllers 30 which execute a control program 31. The store 24 and the material conveyor 25 are also assigned their own controller 30. The controllers 30 are connected communicatively to one another and to a remote memory 32 via a bus 34, in particular a field bus.

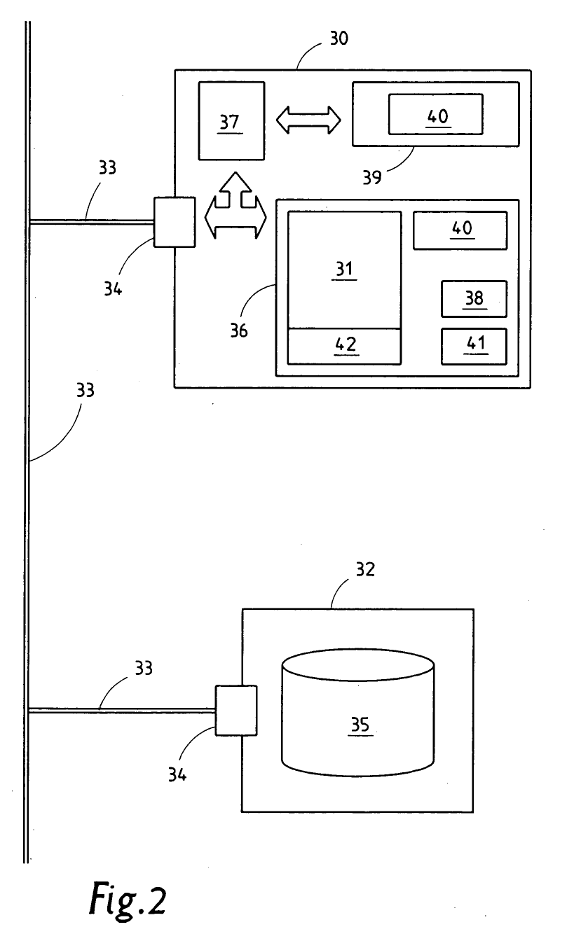

FIG. 2 shows, schematically, one of the controllers 30, which is connected to the bus 33 via an interface 34, that is to say a bus interface. Likewise connected to the bus 33 is the remote memory 32, specifically via its own interface 34. The remote memory 32 has a memory 35, such as a hard disk or the like. Each controller 30 has, in a known way, a main memory 36. This is usually implemented as a random access memory (RAM). The control program 31 is stored in the main memory 36. The control program 31 comprises, encoded as program instructions, instructions for controlling and/or influencing the respectively controlled fabrication unit or individual elements, for example motors, valves or the like, of this fabrication unit. The control program 31 is implemented in a manner known per se by a device provided for the purpose and belonging to the controller 30, for example a microprocessor 37. Also stored in the main memory 36 is an operating system 38, which includes basic functions, for example the operation of the interface 34, and to which access is made during execution of the control program 31. In the case of special controllers, the functionality of the operating system can be contained completely in the control program 31. Then, no separate operating system 38 is required in the main memory 36. In addition to the main memory 36, the controller 30 is assigned a memory module 39. Configuration data 40 are stored in the memory module 39. A boot-strap program 41 is stored in the main memory 36. When the controller is restarted, that is to say when the controller 30 is switched on for the first time or when power returns, the boot-strap program 41 is executed. The boot-strap program 41 resets the controller 32 to defined conditions upon restarting. Furthermore, the boot-strap program 41 starts a user program. If there is an existing control program 31, the boot-strap program 41 therefore starts the control program 31. In the case of a new controller 30 which, for example in the event of service, has replaced a defective controller 30, there is initially still no control program 31. Instead, there is an installation program 42 in the main memory 36. When such a new controller 30 is switched on, the boot-strap program 41 starts the installation program 42.

The functionality of the installation program 42 and also the use of the configuration data 40 will be explained below. As already explained, a new controller 30 does not comprise any control program 31. This means that such a new controller 30 is not immediately ready for use for controlling and/or monitoring specific functional units. Hitherto, complicated reconfiguration of the controller 30 was required here. This is now avoided by the invention. The installation program 42 called by the boot-strap program 41 automatically effects configuration of the new controller 30 in such a way that the new controller 30 has all the data to which a failed controller 30 which is replaced by the new controller 30 had access. For the configuration of the new controller 30, the installation program 42 initially makes access to the configuration data 40 in the memory module 39. These configuration data 40 comprise at least one unique address of the controller on the bus 33. This address is transmitted to the interface 34, so that the new controller 30 can send and receive data via the bus 33. Furthermore, the configuration data 40 comprise memory location data with regard to a memory location of a copy of the control program 31. By using the memory location data, the controller 30, under the control of the installation program 42, makes access to the memory location of the copy of the control program 31, in particular the last or most up-to-date copy, that is to say, for example, to the memory 35 of the remote memory 32. During this access, there is a transfer of the copy of the control program 31 into the main memory 36 of the new controller 30. During the transfer of the copy of the control program 31 into the main memory 36, either the installation program 42 or a reference to calling the installation program 42 is overwritten in such a way that, when the controller 30 is next restarted, the boot-strap program 41 executes the control program 31.

During operation of the controller 30, either under the control of the control program 31 or of the operating system 38, at predefined or predefinable times, in particular at equidistant time intervals, a copy of the control program 31 is stored outside the controller 30, that is to say preferably in an external memory 32, but possibly also in a main memory 36 of a further controller 30. The memory location of this copy of the control program 31 is appended to the configuration data 40 in order to permit subsequent access to the copy of the control program. In connection with the present invention, the term control program 31 relates not only to the actual program instructions but also to the data treated or processed by the control program, that is to say for example input data, output data and, for example, register contents or data for intermediate or partial results, what are known as markers. In the event of failure of a controller 30, this can be replaced by a new controller 30 which, under control of the installation program 42, looks for a copy of the control program 31 and transfers this into the main memory 36 of the new controller 30. Following this transfer, the new controller 30 can perform the functionality of the failed controller 30. A controller replacement of this type may be made in a few instants, particularly against the background in which the controllers are frequently kept in a module carrier (not illustrated). Stoppage times of the controlled technical installation are therefore reduced to a minimum, even in the event of service. In order to increase the integrity still further, provision can be made for a plurality of copies of control programs 31 to be stored on the communication participants which can be reached via the bus 33, that is to say other controllers 30 or one or more remote memories 32. Then, automatic configuration of a failed controller 30 is subsequently possible even if, in addition to the controller 30, for example the central memory 32 on which a copy of the control program 31 is stored fails. In such a case, the installation program 42 of the new controller falls back specifically on the memory location of an earlier copy of the control program 31. For this purpose, the configuration data 40 comprise a list of memory location data with regard to a memory location of the respective copy of the control program. In this case, either the last element of such a list of memory location data can specify the memory location of the last copy of the control program, or provision is made for the memory location data additionally to comprise an item of time information, so that, by using the item of time information, the most up-to-date accessible copy of the control program 31 can be determined.

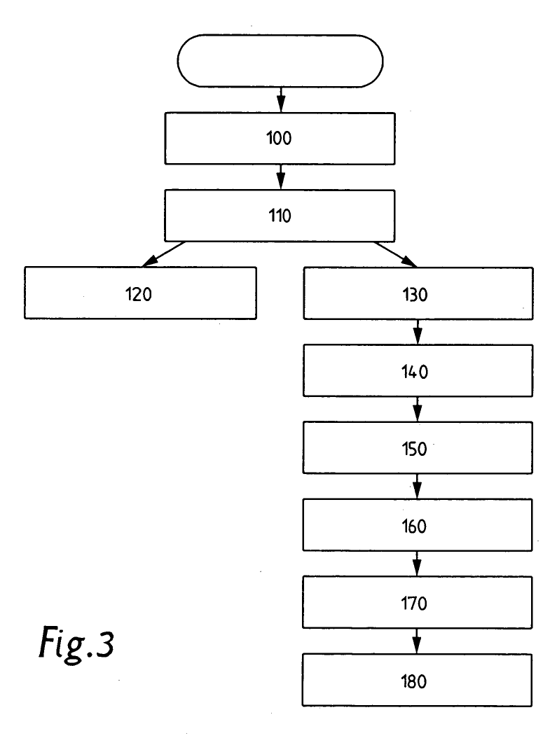

FIG. 3 shows the progress of the method in a flow chart. When the controller 30 is started up or restarted, that is to say when the supply voltage is switched on or returns, first of all the boot-strap program 41 is started (step 100). The boot-strap program carries out minimal initialisation, determined in a manner known per se, in relation to the hardware of the controller 30. Following this, the boot-strap program causes the execution of software which, in the main memory 36, either begins at a specific memory cell (start address) or whose start address is stored in a specific memory cell (step 110). If the software called in this way is the control program 31, the control program 31 is executed (step 120). During the execution of the control program 31, at predefined or predefinable times, in particular at equidistant times, a copy of the control program 31 is stored in a memory which can be reached via the bus 33, that is to say for example the remote memory 32, or in the main memory 36 of another controller 30. The memory location, that is to say the address of this copy of the control program 31, is appended to the configuration data 40. Likewise, during the execution of the control program, continuous updating of important configuration data 40 in a memory provided for this purpose, that is to say for example of the memory module 39, is carried out.

On the other hand, if the software called by the boot-strap program 41 is the installation program 42, the latter is started (step 130). The installation program 42 makes access to the memory module 39 and reads out the configuration data 40 stored there (step 140). The configuration data 40 comprise the address of the controller 30 on the bus 33. The installation program 42 configures the controller 30 in accordance with the bus address read out, so that the controller 30 can participate in the data traffic via the bus 33 (step 150). The configuration data 14 further comprise the memory location of a copy of the control program 31. The installation program 42 makes access to the memory location, that is to say firstly the remote memory 32 or the relevant controller 30, and then to the local memory location, that is to say for example to a file specified with a file name in a directory tree or a section of a memory specified with start and end address, and causes a transfer of the selected copy of the control program 31 into the main memory 36 of the controller 30 (step 160). During the transfer of the control program 31 into the main memory 36, the installation program 42 is overwritten by the control program 31 in such a way that the control program 31 begins in the main memory 31 at the same point in the memory at which the installation program 42 was previously stored. Alternatively, provision can also be made for a point in the memory which had previously contained the start address of the installation program 42 to be overwritten with the start address of the control program 31 (step 170). Finally, restarting of the controller 30 is triggered. This can be carried out automatically (step 180). If automatic restarting of the controller 30 is not possible, the completion of the transfer of the control program 31 is indicated visually or acoustically to a user, so that the latter then arranges to restart the controller 30 manually, for example by switching off the mains voltage and switching it on again.

When the supply voltage returns, the boot-strap program 41 is then started again (step 100), which causes the control program 31 now present on the controller 30 to be called (step 110).

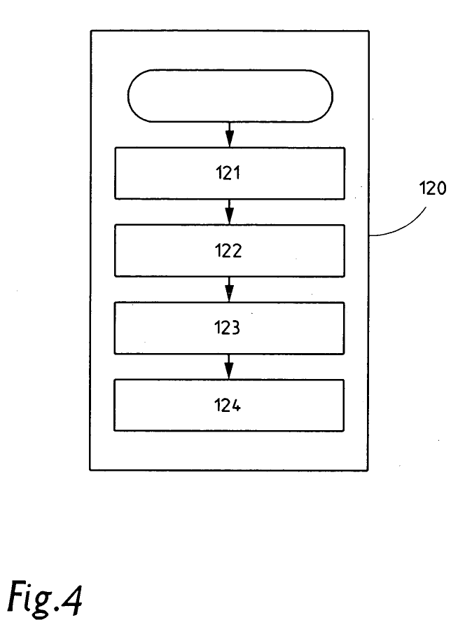

The execution of the control program 31 (step 120) will be explained below using FIG. 4. When the control program 31 is started, the usual initialisation is carried out in a manner known per se, that is to say for example an initialisation of data and variables used in the control program 31 to predefined or predefinable values (step 121). After that, machine data with respect to a machine, that is to say a fabrication unit, such as maker 10, packer 11 or the like, for which the control program 31 is provided, are read out from the configuration data 40. Furthermore, machine codes are read out from the connected machine, that is to say the fabrication unit to which the controller 30 is assigned (step 122). A comparison between the data read out is then carried out (step 123). The execution of the control program 31 is terminated, for example with a suitable error or status message, if the machine data and the machine codes do not match one another (step 124). Machine data and the machine codes match one another if they are identical or agree with regard to specific positions. The machine data and the machine codes are, for example, a serial number, a type designation, a combination of the two or parts of the same or the like.

The machine data read out, together with further important data which are necessary to the operation of the controller (configuration data 40) are stored in the memory module 39 under the control of the control program 31.

The memory module 39 is in particular a memory module 39 which can be separated from the controller 30, which, therefore, in the case of a required replacement of a controller 30, is initially removed from the controller 30 to be replaced and, following installation of a new controller 30, is inserted into the new controller 30. The memory module 39 is fixed in the region of an installation location of the controller 30, that is to say to a control cabinet, control box or control desk or to a module carrier for holding a controller 30 (none of these illustrated) such that it can move, for example by means of a chain or the like. This ensures that the memory module 39 is not lost and that the memory module 39 can be inserted only into a controller 30 which is installed at the installation location within the range of mobility of the memory module 39.

List of Designations

10 Maker

11 Packer

12 Film wrapping machine

13 Carton packer

14 Cartoner

15 Cigarette conveyor

16 Blank store

17 Blank store

18 Pack conveyor

19 Carton conveyor

20

21 Output conveyor

22 Pack store

23 Filter-tipping machine

24 Material store

25 Material conveyor

26 Bobbin

27 Conveyor belt

28

29

30 Controller

31 Control program

32 Remote memory

33 Bus

34 Interface

35 Memory

36 Main memory

37 Microprocessor

38 Operating system

39 Memory module

40 Configuration data

41 Boot-strap program

42 Installation program

What is Claimed is:

1. Method of operating a device for controlling or monitoring a production and/or packaging installation for the production and/or packaging of cigarettes, cigars and the like—controller (30)—on a communication medium, namely a bus (33), the controller (13) comprising an interface (34) to be connected to the communication medium, a main memory (36) for the storage of a control program (31) and also means for executing the control program (31), characterized in that configuration data (40) are stored in a removeable memory module (39) in that, when the controller (30) is restarted, the configuration data (40) are read out and in that, by using the configuration data (40), an access to a remote memory (32) which can be reached via the communication medium is made, which comprises a transfer to the controller (30) of data stored in the remote memory (32).

2. Method according to claim 1, characterized in that the configuration data (40) comprise a unique address of the controller (30) on the communication medium, and in that, when the controller (30) is restarted, the interface (34) is configured with the address.

3. Method according to claim 2, characterized in that in the main memory (36) of the controller (30) there is stored an installation program (42) which is executed when the controller (30) is restarted, in that the execution of the installation program (42) comprises an access to the configuration data (40), in that by using the configuration data (40) an access is made to the remote memory (32) which can be reached via the communication medium, and in that this access comprises a transfer of the copy of the control program (31) stored in the remote memory (32) into the main memory (36) of the controller (30).

4. Method according to claim 3, characterized in that, during the transfer of the copy of the control program (31) into the main memory (36) of the controller (30), a reference to calling the installation program (42) is overwritten by a reference to calling the control program (31).

5. Method according to claim 3, characterized in that, during the transfer of the copy of the control program (31) into the main memory (36) of the controller (30), the installation program (42) in the main memory (36) is overwritten.

6. Method according to claim 3, characterized in that the configuration data (40) comprise memory location data with regard to a memory location of the copy of the control program (31), in particular with regard to the memory location of a last copy of the control program (31).

7. Method according to claim 6, characterized in that the transfer of the copy of the control program (31) into the main memory (36) of the controller (30) is carried out by using the memory location data from the last memory location.

8. Method according to claim 1, characterized in that the configuration data (40) comprise machine data with regard to a machine for which the control program (31) is provided, and that, when the controller (30) is restarted, before or with the start of the control program (31), a comparison is made between the machine data and machines codes read in from the controlled or monitored production or packaging installation, and in that the control program (31) is executed only when the machine codes match the machine data.

9. Device for controlling or monitoring a production and/or packaging installation for the production or packaging of cigarettes, cigars and the like—controller (30)—, comprising a main memory (36), in which a control program (31) can be stored, a device for executing the control program (31) and an interface (34) for connection to a communication medium, in particular a bus (33), characterized in that configuration data (40), which can be read out and evaluated when the controller (30) is restarted, are stored in a removeable memory module (39), the memory module (39) being fixed at an installation location of the controller (30) such that it can move.

10. Method according to claim 4, characterized in that, during the transfer of the copy of the control program (31) into the main memory (36) of the controller (30), the installation program (42) in the main memory (36) is overwritten.
